(19) United States
(12) Patent Application Publication
(10) Pub. No.: US 2005/0216614 A1
(43) Pub. Date: Sep. 29, 2005

(54) Microcomputer having instruction RAM

(75) Inventor: Tetsuya Sakairi, Kanagawa (JP)

Correspondence Address: FOLEY AND LARDNER;SUITE 500, 3000 K STREET NW, WASHINGTON, DC, 20007, US

(73) Assignee: NEC Electronics Corporation

(21) Appl. No.: 11/054,550

(22) Filed: Feb. 10, 2005

(30) Foreign Application Priority Data
Mar. 26, 2004 (JP) 2004-092120

(51) Int. Cl. G06F 13/28

(52) U.S. Cl. 710/22; 711/165

(57) ABSTRACT

A microcomputer comprises an instruction RAM temporally storing a program transferred from an external memory, a CPU reading out the program from the instruction RAM via a dedicated fetch bus and carrying out a process according to the program, an instruction transfer control circuit directly transferring the program from the external memory to the instruction RAM via a dedicated transfer bus, and a transfer information register temporally storing instruction transfer information which has been stored in the external memory and is necessary information for transferring the program from the external memory to the instruction RAM by the instruction transfer control circuit.

### BACKGROUND OF THE INVENTION

1. Field of the Invention

This invention relates to microcomputers, in particular, the microcomputer incorporating an instruction RAM for temporarily storing a program to be executed in CPU.

2. Description of Related Art

In recent microcomputers, the processing speed of the incorporated CPU has been increased, resulting in that the memory access delay causes the limited CPU processing speed. In conventional configurations, in order to reduce the memory weight of the CPU and shorten the processing time, a program is transferred from an external non-volatile memory to a fast internal RAM and the program is then read out from the internal RAM. FIG. 5 shows an example of the conventional microcomputer which includes a RAM for temporarily storing such a program (hereafter, referred to as “instruction RAM”). The microcomputer with the configuration as shown in FIG. 5 is disclosed in, for example, Japanese Unexamined Patent Application Publication No.2001-195261.

FIG. 5 shows a block diagram of the conventional microcomputer.

As shown in FIG. 5, the conventional microcomputer 3 comprises a CPU 31, an instruction RAM 32 which temporarily stores a program to be executed by the CPU 31, a memory control circuit (MEMC) 33 which reads out the program from an external memory 4 according to the instruction of the CPU 31 and transfers it to the instruction RAM 32, and a boot ROM 34 which stores a boot program for controlling the program transfer from the external memory 4 to the instruction RAM 32 and a reset vector that is the information determining the operation during the reset of the CPU. The CPU 31 is connected to the boot ROM 34 and the instruction RAM 32 via dedicated buses (fetch bus) for reading out the program respectively. The CPU 31 is connected to the memory control circuit 33 via a system bus. The system bus and the fetch bus comprise the address bus for transferring address signals (Add), and the data bus for transferring programs (Ins) and data (Data).

In such a configuration, once the microcomputer in FIG. 5 starts up, the CPU 31 reads out the reset vector and the boot program from the boot ROM 34 respectively, and first, carries out the known reset process according to the reset vector. Upon the completion of the reset process, the CPU 31 transfers the program from the external memory 4 to the instruction RAM 32 via the system bus according to the boot program. Then, upon the completion of the program transfer based on the capacity of the instruction RAM 32 and the size of the program, the CPU 31 reads out the program transferred to the instruction RAM 32 via the fetch bus, and carries out the initial setting and the predetermined process according to the program in sequence.

As described above, in the conventional microcomputer, the program transfer from the external memory to the internal instruction RAM is controlled at the CPU, so that other processes cannot be performed at the CPU during the program transfer to the instruction RAM. Accordingly, the delay of the process occurs because it is required to wait until the program transfer to the instruction RAM is completed, causing the problem of performance degradation of the microcomputer.

In addition, the program is transferred from the external memory to the instruction RAM according to the boot program stored in the boot ROM that is a non-volatile memory. Thus, there is a problem that it is not easy to modify the weight information and the operation mode according to the type of the external memory, which is the transfer origination, and the transfer destination and transfer capacity of the program.

In addition, the read-instruction/write-instruction are repeatedly issued from the CPU to the memory control circuit via the system bus to read out the program from the designated address of the external memory and write the read program to the designated address of the instruction RAM, causing the problem of the slow program transfer speed.

### SUMMARY OF THE INVENTION

According to one aspect of the present invention, there is provided a microcomputer comprising an instruction RAM temporally storing a program transferred from an external memory, a CPU reading out the program from the instruction RAM via a dedicated fetch bus and carrying out a process according to the program, an instruction transfer control circuit directly transferring the program from the external memory to the instruction RAM via a dedicated transfer bus, and a transfer information register temporally storing instruction transfer information which has been stored in the external memory and is necessary information for transferring the program from the external memory to the instruction RAM by the instruction transfer control circuit. In the microcomputer configured as above, the transfer of the program from the external memory to the instruction RAM is executed by the instruction transfer control circuit. Therefore, the CPU can carry out another process during the transfer of the program. Thus, the performance degradation of the microcomputer due to the program transfer to the instruction RAM is prevented.

Further, the instruction transfer information necessary for the program transfer is transferred from the external memory to the transfer information register, and the program transfer from the external memory to the instruction RAM is controlled by referring to the instruction transfer information. Thus, the program transfer process can be optimized according to the type of the external memory and the size of the program. In addition, the program is directly transferred from the external memory to the instruction RAM via the dedicated transfer bus by the instruction transfer control circuit, allowing the program transfer speed to be improved.

According to another aspect of the present invention, there is provided a microcomputer comprising an instruction RAM temporally storing a program transferred from an external memory, an instruction transfer control circuit directly transferring the program from the external memory to the instruction RAM via a dedicated transfer bus, and generating a transfer completion signal indicative of the transfer completion of the corresponding program every time when each transfer of the program to the instruction RAM is completed, a transfer information register temporally storing instruction transfer information which has been stored in the external memory and is necessary information for transferring the program from the external memory to the instruction RAM by the instruction transfer control circuit, and a monitor circuit monitoring the transfer completion signal and a program read out from the instruction RAM by the CPU, and if the program read out by the CPU is not completed, sending a wait signal for keeping the readout of the program on standby to the CPU. The configuration of this invention comprises a monitor circuit which monitors a plurality of the instruction RAMs, the transfer completion signal and the program read by the instruction RAM. Thus, even if the program may include the branch statement (the statement of jump or the like), it is possible, with a simple configuration, to keep the fetch of the program on standby at the CPU before the branched program is transferred to the instruction RAM. In particular, the configuration comprising a number of the instruction RAMs, each of which has relatively less capacity, allows the reduced wait time of the CPU.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing the first embodiment of the microcomputer of the present invention;

FIG. 2 illustrates the memory map of the external memory and microcomputer shown in FIG. 1;

FIG. 3 is a block diagram showing the second embodiment of the microcomputer of the present invention;

FIG. 4 illustrates the memory map of the external memory and microcomputer shown in FIG. 3;

FIG. 5 is a block diagram showing the conventional microcomputer.

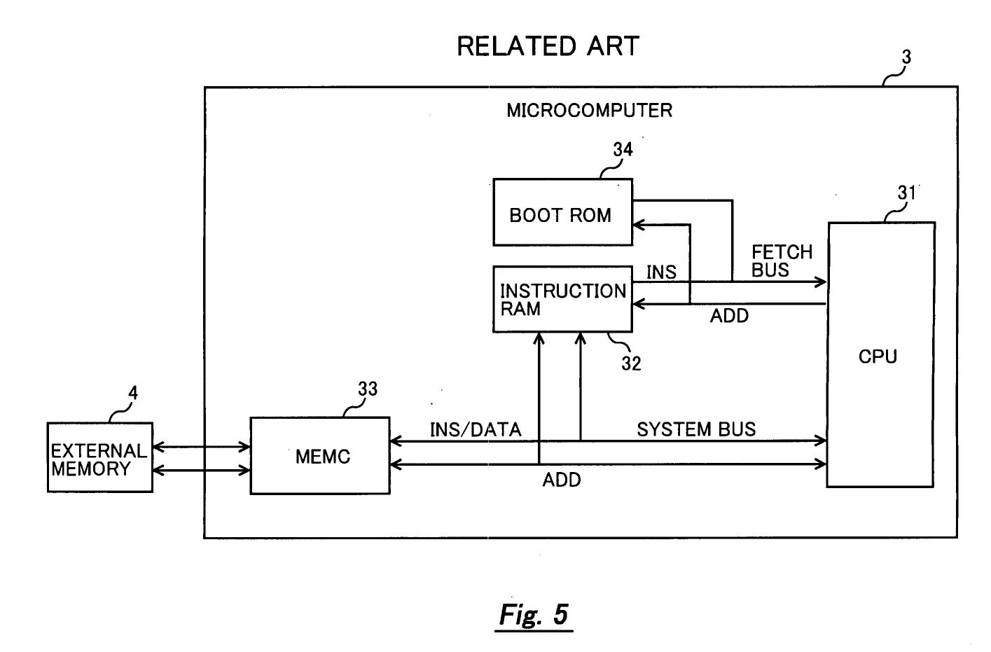

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

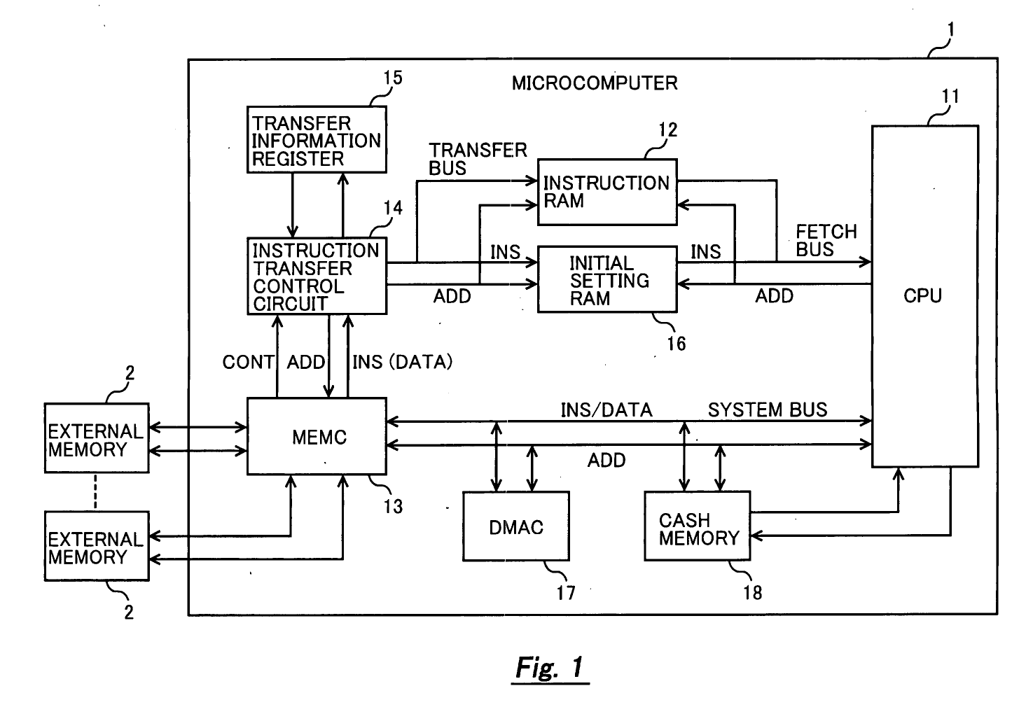

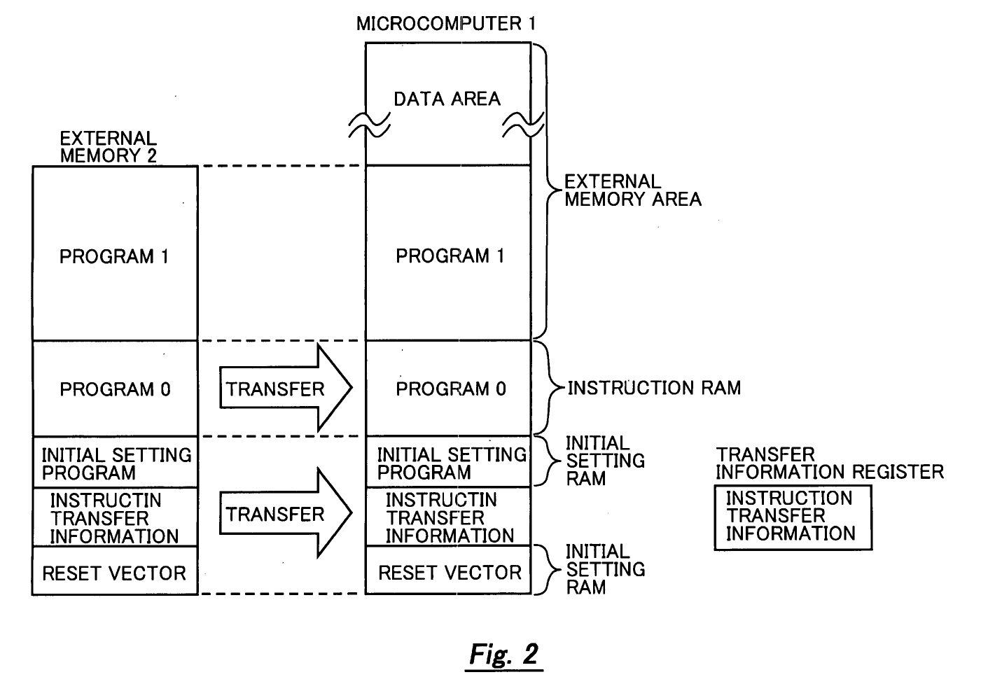

FIG. 1 is a block diagram showing the first embodiment of the microcomputer of the present invention, and FIG. 2 illustrates the memory map of the external memory and microcomputer shown in FIG. 1.

As shown in FIG. 1, the microcomputer 1 of the first embodiment has the configuration that comprises a CPU 11, an instruction RAM 12 which temporally stores the program executed in the CPU 11, an initial setting RAM 16 which temporally stores the reset vector and the program for initial setting (initial setting program), an instruction transfer control circuit 14 which controls the program transfer from the external memory 2 to the instruction RAM 12 and the initial setting RAM 16, a transfer information register 15 which temporally stores the instruction transfer information necessary for the program transfer from the external memory 2, and a memory control circuit (MEMC) 13 which controls the readout/write of the program and data to the external memory 2 according to the instruction from the CPU 11. The instruction transfer control circuit 14 is connected to the instruction RAM 12 and the initial setting RAM 16 via respective dedicated buses (transfer bus) for transferring the program. The CPU 11 is connected to the instruction RAM 12 and the initial setting RAM 16 via respective dedicated buses (fetch bus) for reading out the program. The CPU 11 and the memory control circuit 13 are connected via the system bus.

The system bus, the transfer bus and the fetch bus respectively comprise the address bus for transferring the address signal and the data bus for transferring the program (Ins) or data (Data). The instruction transfer information stored in the transfer information register 15 includes the type of the external memory 2 for reading out the program, the destination address of the program, the number of transfers, the weight setting and the operation mode of the external memory 2, and so on.

It should be noted that it is possible to connect the system bus to the DMA controller (DMAC) 17 which controls the transfer of the Direct Memory Access (DMA) of the program and data to the internal memory (not shown), and it may also be connected to the cash memory 18 which temporally stores the read out program and data from the external memory 2 via the memory control circuit 13. In the configuration with the cash memory 18, the CPU 11 can transfer the program and data from any external memory 2 out of a plurality of the external memories 2 connected to the memory control circuit 13, and carry out the process by reading out the program and data from the cash memory 18. In this case, upon the occurrence of the program fetch to the cash memory 18, the CPU 11 may once stop the operation of the instruction transfer control circuit 14 and repeatedly issue the read-instruction/write-instruction to the memory control circuit 13. In this case, the CPU 11 can read out the program from the designated address of the external memory 2 and write the read out program to the designated address of the cash memory 18.

In such a configuration, according to the microcomputer 1 of the present embodiment, the program transfer from the external memory 2 to the instruction RAM 12 or the initial setting RAM 16 is controlled by the instruction transfer control circuit 14.

When starting up or turning on the microcomputer, the instruction transfer control circuit 14 first reads out the reset vector, the above instruction transfer information and the initial setting program from the external memory 2 respectively, then writes the reset vector and the initial setting program to the initial setting RAM 16, and writes the instruction transfer information to the transfer information register 15 by referring to FIG. 2. Next, the instruction transfer control circuit 14 reads out the program (the program 0 in FIG. 2) from the external memory 2 in sequence, then transfers the read out program to the instruction RAM 12 by referring to the instruction transfer information stored in the transfer information register 15, and stores it in the address designated by the instruction transfer information. The program is directly transferred from the instruction transfer control circuit 14 to the initial setting RAM 16 and the instruction RAM 12 via the transfer bus as the way of the known DMA.

Upon the completion of the transfer of the reset vector and the initial setting program to the initial setting RAM 16, the CPU 11 reads out the reset vector and the initial setting program from the initial setting RAM 16, and then carries out the predetermined reset process and initial setting process according to the program.

During the reset process and the initial process by the CPU 11, the instruction transfer control circuit 14 also reads out the program from the external memory 2 in sequence and transfers it to the instruction RAM 12. Upon the completion of the initial setting process, the CPU 11 reads out the program which has so far been transferred to the instruction RAM 12 in sequence, and carries out the predetermined process according to the program.

Thus, according to the configuration of the present embodiment, it is possible to transfer the program from the external memory 2 to the instruction RAM 12 by the instruction transfer control circuit 14 and, at the same time, carry out the process by the CPU 11, preventing the performance degradation of the microcomputer 1 due to the program transfer process to the instruction RAM 12.

In addition, the external memory 2 stores the information including the destination address, the number of the program transfers, the weight setting and the operation mode of the external memory 2. When starting up the microcomputer 1, these pieces of the information are transferred to the transfer information register 15 from the external memory 2, and the program transfer from the external memory 2 to the instruction RAM 12 is controlled by referring to the information. Thus, the program transfer process can be optimized according to the type of the external memory 2 and the size of the program. Further, the program is directly transferred by the instruction transfer control circuit 14 via the dedicated transfer bus from the external memory 2 to the instruction RAM 12, so that the program transfer speed is improved.

### Second Embodiment

The microcomputer 1 of the first embodiment reads out the program from the instruction RAM 12 at the CPU 11 and starts the process of the program before the completion of the transfer of the predetermined size of the program from the external memory 2 to the instruction RAM 12. Thus, if the branch statement (statement of jump or the like) is included in the program, the CPU 11 is required to keep the process on standby until the transfer of the branched program to the instruction RAM 12 is completed by the instruction transfer control circuit 14 (wait process). The microprocessor 1 of the second embodiment provides the configuration for realizing a simple wait process.

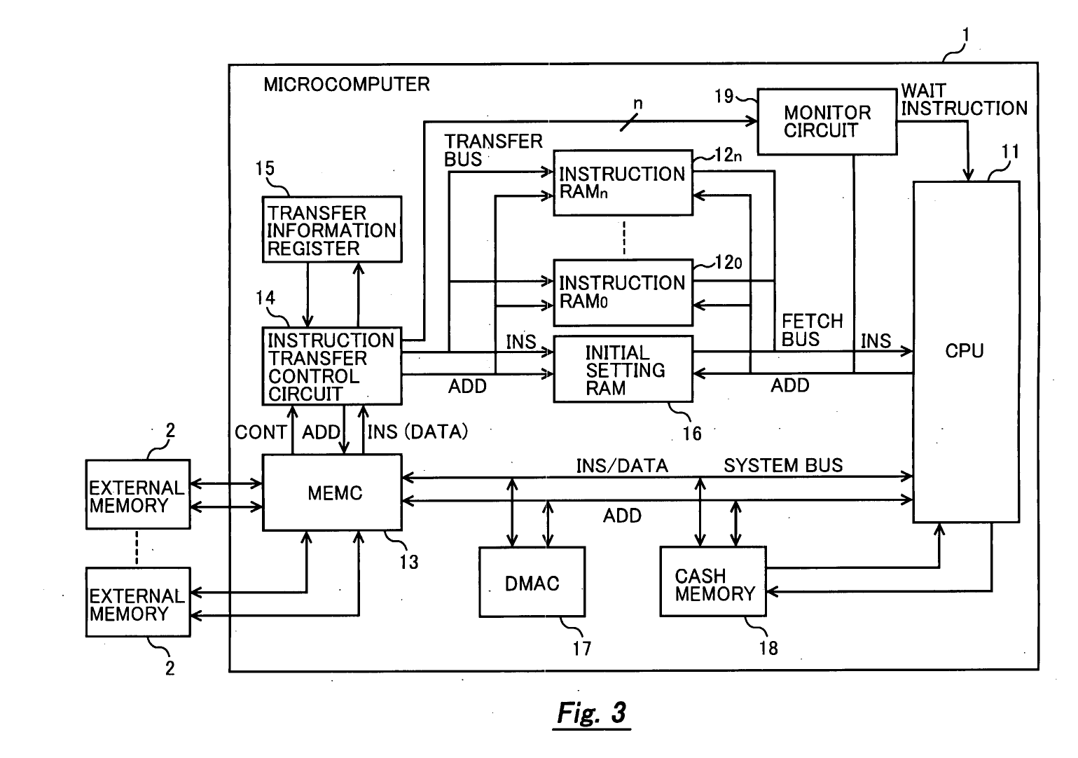

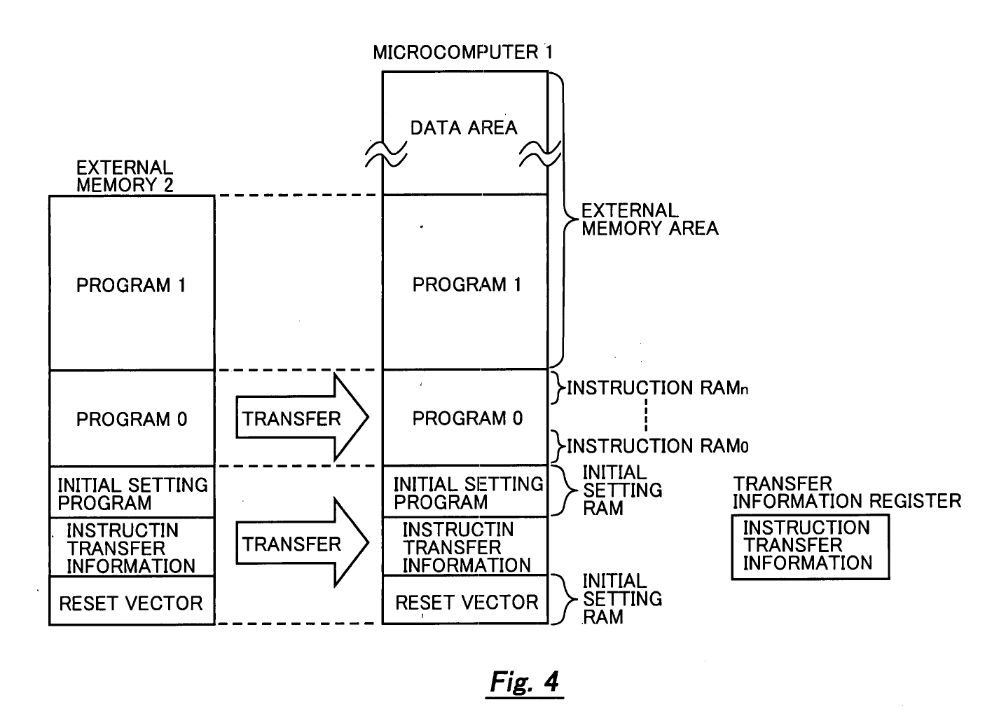

FIG. 3 is a block diagram showing the second embodiment of the microcomputer of the present invention, and FIG. 4 illustrates the memory map of the external memory and microcomputer shown in FIG. 3.

As shown in FIG. 3, the microcomputer of the second embodiment comprises, in addition to the microcomputer 1 shown in the first embodiment, a plurality of the instruction RAMs 0-n (n is a positive integer) and a monitor circuit 19 which monitors whether or not the transfer of the program to each of the instruction RAMs 0-n is completed. Since other parts of the configuration are the same as those of the first embodiment, the explanation thereof is omitted. FIG. 3 shows that the codes 120-12n are assigned to the instruction RAMs 0-n.

The monitor circuit 19 comprises, for example, a table representing the relation between the transfer range (address) and the transfer completion signals of the programs corresponding to respective instruction RAMs 0-n. The monitor circuit 19 compares the readout address of the program to respective instruction RAMs 0-n, which is issued by the CPU 11, with the transfer completion signal, which is transmitted from the instruction transfer control circuit 14. If the read out address of the program exceeds the transfer range of the program, that is, if the program read out by the CPU has not been sent to any of the instruction RAMs 0-n, the wait instruction for keeping the readout of the program on standby is sent to the CPU 11. Upon the reception of the wait instruction from the monitor circuit 19, the CPU 11 stops the program fetch from the instruction RAMs 0-n until the wait instruction is canceled. In addition, in the configuration of the microcomputer in accordance with the present invention, if employing a number of the instruction RAMs, each of which has relatively less capacity, it is possible to detect the range of the transferred program on a smaller size basis. This allows the reduced time duration from the time when the program to be read out has been transferred, to the time when the transfer completion signal is outputted, so that the wait time of the CPU 11 is reduced.

According to the configuration of the second embodiment, even if the program includes the branch statement (the statement of jump or the like), it is possible to keep the fetch of the program on standby at the CPU 11 until the branched program is transferred to the instruction RAMs 0-n. In particular, it is possible to reduce the wait time of the CPU 11 by employing the configuration having a number of instruction RAMs of relatively less capacity.

It is apparent that the present invention is not limited to the above embodiment and it may be modified and changed without departing from the scope and spirit of the invention.

1. A microcomputer comprising;
an instruction RAM temporally storing a program transferred from an external memory,
a CPU reading out the program from the instruction RAM via a dedicated fetch bus and carrying out a process according to the program,
an instruction transfer control circuit directly transferring the program from the external memory to the instruction RAM via a dedicated transfer bus, and
a transfer information register temporally storing instruction transfer information which has been stored in the external memory and is necessary information for transferring the program from the external memory to the instruction RAM by the instruction transfer control circuit.

2. The microcomputer of claim 1, further comprising;
an initial setting RAM temporally storing a reset vector and an initial setting program transferred from the external memory,
wherein the instruction transfer control circuit directly transfers the reset vector and the initial setting program from the external memory to the initial setting RAM via a dedicated transfer bus, and
wherein the transfer information register temporally stores instruction transfer information which has been stored in the external memory and is necessary information for transferring the reset vector and the initial setting program from the external memory to the initial setting RAM by the instruction transfer control circuit.

3. The microcomputer of claim 1, further comprising;
a memory control circuit, connected to the CPU via a system bus, executing readout/write of a program and data to the external memory by the control of the CPU and
a cash memory, connected to the system bus, temporally storing a program and data read out from the external memory via the memory control circuit and being necessary for the process to be carried out at the CPU.

4. The microcomputer of claim 1, further comprising;
a memory control circuit, connected to the CPU via a system bus, executing readout/write of a program and data to the external memory by the control of the CPU, and
a DMA controller controlling DMA transfer of a program and data read out from the external memory via the memory control circuit to an internal memory and being necessary for the process to be carried out at the CPU.

5. A microcomputer comprising;
an instruction RAM temporally storing a program transferred from an external memory,
an instruction transfer control circuit directly transferring the program from the external memory to the instruction RAM via a dedicated transfer bus, and generating a transfer completion signal indicative of the transfer completion of the corresponding program every time when each transfer of the program to the instruction RAM is completed,
a transfer information register temporally storing instruction transfer information which has been stored in the external memory and is necessary information for transferring the program from the external memory to the instruction RAM by the instruction transfer control circuit, and
a monitor circuit monitoring the transfer completion signal and a program read out from the instruction RAM by the CPU, and if the program read out by the CPU is not completed, sending a wait signal for keeping the readout of the program on standby to the CPU.

6. The microcomputer of claim 5, further comprising;
an initial setting RAM temporally storing a reset vector and an initial setting program transferred from the external memory,
wherein the instruction transfer control circuit directly transfers the reset vector and the initial setting program from the external memory to the initial setting RAM via a dedicated transfer bus, and
wherein the transfer information register temporally stores instruction transfer information which has been stored in the external memory and is necessary information for transferring the reset vector and the initial setting program from the external memory to the initial setting RAM by the instruction transfer control circuit.

7. The microcomputer of claim 5, further comprising;
a memory control circuit, connected to the CPU via a system bus, executing readout/write of a program and data to the external memory by the control of the CPU and
a cash memory, connected to the system bus, temporally storing a program and data readout from the external memory via the memory control circuit and being necessary for the process to be carried out at the CPU.

8. The microcomputer of claim 5, further comprising;
a memory control circuit, connected to the CPU via a system bus, executing readout/write of a program and data to the external memory by the control of the CPU, and
a DMA controller controlling DMA transfer of a program and data read out from the external memory via the memory control circuit to an internal memory and being necessary for the process to be carried out at the CPU.
